(19) United States
(12) Patent Application Publication
(10) Pub. No.: US 2005/0288438 A1
(43) Pub. Date: Dec. 29, 2005

(54) Stabilized polyoxymethylene compositions with low melt viscosity

(76) Inventor: Malay Nandi, Parkersburg, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/877,548

(22) Filed: Jun. 25, 2004

(51) Int. Cl. C08L 63/00

(52) U.S. Cl. 525/110

(57) ABSTRACT

A thermally stabilized, low melt viscosity polyoxymethylene resin composition that comprises an epoxidized fatty acid stabilizer and at least one polymer containing formaldehyde reactive nitrogen groups.

### FIELD OF THE INVENTION

The present invention relates to a thermally stabilized polyoxymethylene resin composition with decreased melt viscosity that comprises an epoxidized fatty acid stabilizer and at least one polymer containing formaldehyde reactive nitrogen groups.

### BACKGROUND OF THE INVENTION

Polyoxymethylene (also known as polyacetal) has excellent tribology, hardness, stiffness, moderate toughness, low coefficient of friction, good solvent resistance, and the ability to crystallize rapidly, making polyoxymethylene resin compositions useful for preparing articles for use in many demanding applications. However, during melt-processing, polyoxymethylenes can degrade and release formaldehyde. It would be desirable to have polyoxymethylene compositions that have improved thermal stability during melt-processing.

The following disclosure may be relevant to various aspects of the present invention and may be briefly summarized as follows: the use of epoxidized drying oils including epoxidized soya oil as polyoxymethylene stabilizers has been reported in U.S. Pat. No. 3,210,318.

### SUMMARY OF THE INVENTION

Briefly stated, and in accordance with one aspect of the present invention, there is provided a thermally stabilized polyoxymethylene composition comprising:
(a) about 40 to about 99 weight percent polyoxymethylene,
(b) about 0.1 to about 5 weight percent of at least one epoxidized fatty acid,
(c) about 0.05 to about 3 weight percent of at least one polymeric stabilizer containing formaldehyde reactive nitrogen groups,
   wherein the weight percentages are based on the total weight of the composition

### DETAILED DESCRIPTION OF THE INVENTION

The present invention is a thermally stabilized polyoxymethylene composition comprising at least one polyoxymethylene, at least one epoxidized fatty acid thermal stabilizer, and at least one polymeric stabilizer containing formaldehyde reactive nitrogen groups.

The polyoxymethylene (i.e. POM or polyacetal) used in the present invention can be one or more homopolymers, copolymers, or a mixture thereof. Homopolymers are prepared by polymerizing formaldehyde or formaldehyde equivalents, such as cyclic oligomers of formaldehyde. Copolymers can contain one or more comonomers generally used in preparing polyoxymethylene compositions. Commonly used comonomers include acetals and cyclic ethers that lead to the incorporation into the polymer chain of ether units with 2-12 sequential carbon atoms. If a copolymer is selected, the quantity of comonomer will not be more than 20 weight percent, preferably not more than 15 weight percent, and most preferably about two weight percent. Preferable comonomers are 1,3-dioxolane, ethylene oxide, and butylene oxide, where 1,3-dioxolane is more preferred, and preferable polyoxymethylene copolymers are copolymers where the quantity of comonomer is about 2 weight percent. It is also preferred that the homo- and copolymers are: 1) homopolymers whose terminal hydroxy groups are end-capped by a chemical reaction to form ester or ether groups; or, 2) copolymers that are not completely end-capped, but that have some free hydroxy ends from the comonomer unit or are terminated with ether groups. Preferred end groups for homopolymers are acetate and methoxy and preferred end groups for copolymers are hydroxy and methoxy.

The polyoxymethylenes used in the compositions of the present invention can be branched or linear and will generally have a number average molecular weight of at least 10,000, preferably 20,000-90,000. The molecular weight can be conveniently measured by gel permeation chromatography in m-cresol at 160° C. using a DuPont PSM bimodal column kit with nominal pore size of 60 and 1000 Å. The molecular weight can also be measured by determining the melt flow using ASTM D1238 or ISO 1133. The melt flow will be in the range of 0.1 to 100 g/min, preferably from 0.5 to 60 g/min, or more preferably from 0.8 to 40 g/min. for injection molding purposes. Other structures and processes such as films, fibers, and blow molding may prefer other melt viscosity ranges. The polyoxymethylene will preferably be present in the composition in about 40 to about 99 weight percent, based on the total weight of the composition.

The fatty acid thermal stabilizer used in the present invention is at least one epoxidized fatty acid containing about 16 to about 20 carbon atoms. By “epoxidized fatty acid” is meant an unsaturated fatty acid or unsaturated fatty acid ester containing one or more double bonds in which at least about 90% of the double bonds have been epoxidized. Examples of suitable epoxidized fatty acids include epoxidized oleic acid, epoxidized linoleic acid, and epoxidized linolenic acid. The stabilizer may also contain saturated fatty acids preferably containing about 12 to about 20 carbon atoms.

Preferred stabilizers are epoxidized soybean oil and epoxidized linseed oil. The epoxidized fatty acid is preferably present in about 0.1 to about 5 weight percent, or more preferably in about 0.2 to about 1 weight percent, based on the total weight of the composition.

The polymeric stabilizer containing formaldehyde reactive nitrogen groups used in the present invention is described in U.S. Pat. No. 5,011,890, which is hereby incorporated by reference. The polymeric stabilizer can be a homopolymer or copolymer. By “formaldehyde reactive nitrogen groups” is meant pendant groups on the polymer chain that contain a nitrogen bonded to one or, preferably, two hydrogen atoms.

The polymeric stabilizer preferably has at least ten repeat units. It preferably has a weight average molecular weight of greater than 5,000, more preferably greater than 10,000. The polymeric stabilizer is non-meltable at the temperature at which the polyacetal is melt processed. By the term “non-meltable”, it is meant that the polymeric stabilizer has its “major melting point” above the temperature at which the polyacetal is melt processed and thus remains essentially a solid during melt processing of the polyacetal. Alternatively, a polymeric stabilizer is “non-meltable” if the polymeric stabilizer has its “major melting point” below the temperature at which the polyacetal is melt processed but it does not undergo significant melt flow at that temperature. The melt flow rate of the polymeric stabilizer may not be significant because the polymeric stabilizer has a high viscosity, attributed to, for example, high molecular weight or crosslinking. In the case where the polymeric stabilizer has its “major melting point” below the temperature at which the polyacetal is melt processed, the melt flow rate of the polymeric stabilizer, as measured in accordance with ASTM-D 1238, is preferably less than one-tenth that of the polyacetal. The “major melting point” of the polymeric stabilizer can be determined on a differential scanning calorimeter. “Major melting point” is the temperature at which the amount of heat absorbed, by the polymeric stabilizer, is greatest; i.e., it is the temperature at which the polymeric stabilizer shows the greatest endotherm.

The formaldehyde reactive nitrogen groups can be incorporated into the polymeric stabilizer by using an appropriate nitrogen containing monomer, such as, for example, acrylamide and methacrylamide. Preferred nitrogen-containing monomers are those that result in the polymeric stabilizer containing formaldehyde reactive nitrogen groups, wherein there are two hydrogen atoms attached to the nitrogen. The particularly preferred monomer is acrylamide which, when polymerized, results in a polymeric stabilizer having substantially all of the formaldehyde reactive nitrogen groups attached directly as a side chain of the polymer backbone or indirectly as a side chain of the polymer backbone. Alternatively, the formaldehyde reactive nitrogen groups can be generated on the polymeric stabilizer by modification of the polymer or copolymer. The formaldehyde reactive nitrogen groups may be incorporated by either method as long as the resultant polymer prepared therefrom is non-meltable, or is capable of being made non-meltable, at the temperature at which the polyacetal is melt processed.

The quantity of the formaldehyde reactive nitrogen groups in the polymeric stabilizer is preferably such that the atoms in the backbone to which the formaldehyde reactive groups are attached, either directly or indirectly, are separated from each other (i.e., connected to each other) by not more than twenty chain atoms. Preferably, the polymeric stabilizer will contain at least one formaldehyde reactive nitrogen group per each twenty carbon atoms in the backbone of the polymer. More preferably, the ratio of formaldehyde reactive nitrogen groups to carbon atoms in the backbone will be 1:2-1:10 and yet more preferably 1:2-1:5.

The polymeric stabilizer can be a homopolymer or a copolymer. It is preferred that the polymeric stabilizer be polymerized from acrylamide or methacrylamide monomer by free radical polymerization and that the polymeric stabilizer prepared therefrom consist of at least 75 mole percent of units derived from acrylamide or methacylamide. More preferably, it consists of at least 90 mole percent of the above units, even more preferably, it consists of at least 95 mole percent of the above units, and yet more preferably, it consists of at least 99 mole percent of the above unit.

The polymeric stabilizer may be a copolymer in that it is polymerized from more than one monomer. The comonomer may or may not contain formaldehyde reactive nitrogen groups. Examples of other monomers that may be thus incorporated include styrene, ethylene, alkyl acrylates, alkyl methacrylates, N-vinylpyrrolidone, and acrylonitrile. The polymeric stabilizer that is a copolymer must still be non-meltable. It further must possess the required quantity of formaldehyde reactive nitrogen groups, in the required ratio, and it must have the required number average particle size. The comonomer preferably should be added such that it does not unduly minimize the number of moles of formaldehyde reactive groups per gram of polymeric stabilizer. Further, it should not unduly minimize the number of formaldehyde reactive sites per gram of polymeric stabilizer. Specific preferred stabilizers that are copolymeric include copolymers of hydroxypropyl methacrylate with acrylamide, methacrylamide, or dimethylaminoethyl methacrylate.

The polymeric stabilizer is preferably present in about 0.05 to about 3 weight percent, or more preferably in about 0.1 to about 1 weight percent, based on the total weight of the composition.

The compositions of the present invention may optionally further comprise additional components such as about 10 to about 40 weight percent impact modifiers; about 0.1 to about 1 weight percent lubricants; about 0.5 to about 5 weight percent plasticizer; about 0.01 to about 2 weight percent antioxidants; about 3 to about 40 weight percent fillers; about 1 to about 40 weight percent reinforcing agents; about 0.5 to about 10 weight percent nanoclays; about 0.01 to about 3 weight percent thermal stabilizers; about 0.05 to about 2 weight percent ultraviolet light stabilizers; about 0.05 to about 3 weight percent nucleating agents; and/or about 0.2 to about 5 weight percent flame retardants, where all weight percentages are based on the total weight of the composition.

Examples of suitable fillers include glass fibers and minerals such as precipitated calcium carbonate, talc, and wollastonite. Examples of suitable impact modifiers include thermoplastic polyurethanes, polyester polyether elastomers, and core-shell acrylate polymers. Examples of lubricants include silicone lubricants such as dimethylpolysiloxanes and their derivatives; oleic acid amides; alkyl acid amides; bis-fatty acid amides such as N,N′-ethylenebisstearamide; non-ionic surfactant lubricants; hydrocarbon waxes; chlorohydrocarbons; fluorocarbons; oxy-fatty acids; esters such as lower alcohol esters of fatty acids; polyvalent alcohols such as polyglycols and polyglycerols; and metal salts of fatty acids such as lauric acid and stearic acid. Examples of nucleating agents include titanium oxides and talc. Preferred antioxidants are hindered phenol antioxidants such as Irganox® 245 and 1090 available from Ciba. Examples of thermal stabilizers include calcium carbonate, magnesium carbonate, and calcium stearate. Examples of ultraviolet light stabilizers include benzotriazoles, benzophenones, aromatic benzoates, cyano acrylates, and oxalic acid anilides.

The stabilized polyoxymethylene compositions of the present invention are made by melt-blending the components using any known methods. The component materials may be mixed to homogeneity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until homogeneous.

The compositions of the present invention may be molded into articles using any suitable melt-processing technique. Commonly used melt-molding methods known in the art such as injection molding, extrusion molding, blow molding, and injection blow molding are preferred and injection molding is more preferred. The compositions of the present invention may be formed into films and sheets by extrusion to prepare both cast and blown films. These sheets may be further thermoformed into articles and structures that may be oriented from the melt or at a later stage in the processing of the composition. The compositions of the present invention may also be used to form fibers and filaments that may be oriented from the melt or at a later stage in the processing of the composition. The articles may include gears, toys, and lighter and pen bodies.

### EXAMPLES

Polyoxymethylene refers to polyoxymethylene homopolymer with a number average molecular weight of about 45,000.
Drapex® 6.8 is an epoxidized soybean oil manufactured by Crompton Vinyl Additives, Inc. Greenwich, Conn.
Irganox® 245 and 1098 are hindered phenol antioxidants available from Ciba.
Albafil® refers to calcium carbonate with an average particle diameter of 0.7 μm manufactured by Specialty Minerals, Inc.
   Preparation of Compositions:

The ingredients shown in Tables 1 and 8 were combined and extruded using a 5.08 cm Killion single screw extruder at a screw rate of about 60 rpm and with a melt temperature of 210±5° C. Upon the exiting the extruder, the compositions were cooled and cut into pellets.

Examples 1 and 2 contains epoxidized soybean oil as a thermal stabilizer. Comparative Example 1 contains ethylene/vinyl alcohol copolymer as a thermal stabilizer.

TABLE 1

| | Example 1 | Example 2 | Comp. Ex. 1 |
|---|---|---|---|
| Polyoxymethylene | 98.8 | 98.8 | 98.8 |
| Drapex ® 6.8 | 0.6 | 0.6 | — |
| Polyacrylamide | 0.47 | 0.47 | 0.47 |
| Irganox ® 245 | 0.07 | 0.07 | 0.07 |
| Irganox ® 1098 | 0.025 | 0.025 | 0.025 |
| Ethylene/vinyl alcohol | — | — | 0.075 |
| copolymer | | | |
| Poly(ethylene glycol) | — | — | 0.86 |
| N,N′- | 0.025 | 0.025 | 0.025 |
| Ethylenebisstearamide | | | |
| Albafil ® | — | 0.1 | — |

All quantities are given in weight percent.
Determination of Thermal Stability:

The thermal stability of the compositions was determined by heating pellets of the compositions for about 30 minutes at a temperature of 259° C. The formaldehyde evolved during the heating step is swept by a stream of nitrogen into a titration vessel containing a sodium sulfite solution where it reacts with the sodium sulfite to generate sodium hydroxide. The generated sodium hydroxide is continuously titrated with hydrochloric acid to maintain the original pH. The total volume of acid used is plotted as a function of time. The total volume of acid consumed at 30 minutes is proportional to the formaldehyde generated by the heated polyoxymethylene and is a quantitative measure of thermal stability. The percent thermal stability (referred to as TEF-T) is calculated by the following formula:
TEF-T (%)=(V₃₀×N×3.003)/S
where:
V₃₀=the total volume in mL of acid consumed at 30 minutes,
N=the normality of the acid,
3.003=(30.03 (the molecular weight of formaldehyde)×100%)/(1000 mg/g), and
S=the sample weight in grams.
   The results are shown in Table 2.

The melt flow index (MFR) was measured for each sample at 190° C. using ISO Method 1133. The light index (LI) and yellowness index (YI) were determined for each sample using ISO Method E313. The results are shown in Table 2.

Thermal stability was also measured by thermogravimetric analysis. The samples were heated from room temperature to 240° C. while purging with air and held at about 240° C. for about 19.3 minutes while purging with air. The percentages of weight loss are shown in Table 2.

TABLE 2

| | Example 1 | Example 2 | Comp. Ex. 1 |
|---|---|---|---|
| MFR (10 g/min) | 13.8 | 14.0 | 14.5 |
| LI (% reflectance) | 85.5 | 85.5 | 85.4 |
| YI (% reflectance) | 1.8 | 2.5 | 2.2 |
| TEF-T | 0.12 | 0.17 | 0.14 |
| TGA % weight loss | 31.6 | — | 42.4 |

Physical Properties:

The compositions were molded at a melt temperature of about 215±5° C. using ISO International Standard Molding Method No. ISO 294-1 into ISO tensile and notched bars for physical testing. Physical testing was doing using ISO Method 527-1/-2 at 23° C. The physical properties are shown in Table 3.

TABLE 3

| | Example 1 | Example 2 | Comp. Ex. 1 |
|---|---|---|---|
| Tensile strength (MPa) | 70 | 70 | 70 |
| Flexural modulus (MPa) | 2968 | 2994 | 2958 |
| Notched Izod impact (kJ/m²) | 7.84 | 7.48 | 7.62 |
| Elongation at break (%) | 21 | 20 | 20 |
| Unnotched Izod (kJ/m²) | 224 | 182 | 177 |

Air Oven Aging Testing:

The molded bars were aged in a circulating-air oven at 120° C. for 80 days. The bars were removed from the oven at 10-day intervals and cooled to room temperature and their weight loss and physical properties were measured. Five samples were used for each measurement at each temperature and the results were averaged. The percentage weight loss with air oven aging is shown in Table 4. The change in notched Izod impact properties with air oven aging is shown in Table 5. The change in tensile modulus with air oven aging is shown in Table 6. The change in notched Izod impact properties with air oven aging is shown in Table 7.

TABLE 4
Percentage Weight Loss at 120° C.

| Days | Example 1 | Example 2 | Comp. Ex. 1 |
|---|---|---|---|
| 10 | 0.42 | 0.46 | 0.53 |
| 20 | 0.53 | 0.54 | 1.13 |
| 30 | 0.95 | 1.01 | 3.66 |
| 40 | 2.40 | 2.07 | 1.40 |
| 50 | 1.57 | 2.21 | 6.46 |
| 60 | 3.51 | 3.81 | 11.96 |
| 70 | 6.19 | 3.93 | 15.65 |
| 80 | 9.42 | 5.46 | 23.67 |

TABLE 5
Notched Izod (kJ/m²)

| Days | Example 1 | Example 2 | Comp. Ex. 1 |
|---|---|---|---|
| 0 | 7.8 | 7.5 | 7.6 |
| 10 | 8.0 | 6.7 | 7.4 |
| 20 | 7.3 | 6.4 | 3.0 |
| 30 | 6.2 | 4.4 | 2.7 |
| 40 | 5.1 | 3.4 | 2.7 |

TABLE 6
Tensile Modulus (MPa)

| Days | Example 1 | Example 2 | Comp. Ex. 1 |
|---|---|---|---|
| 0 | 69.2 | 69.7 | 69.1 |
| 10 | 70.7 | 70.4 | 67.2 |
| 20 | 68.8 | 69.8 | 53.1 |
| 30 | 58.3 | 60.4 | 49.8 |

TABLE 7
Flexural Modulus (MPa)

| Days | Example 1 | Example 2 | Comp. Ex. 1 |
|---|---|---|---|
| 0 | 2937 | 2994 | 2934 |
| 30 | 3056 | 3096 | 2461 |
| 60 | 2808 | 2803 | 2259 |
| 80 | 2664 | 2564 | 2154 |

The results in Table 3 demonstrate that Examples 1 and 2, containing epoxidized soybean oil, have similar physical properties to Comparative Example 1, which contains an ethylene/vinyl acetate copolymer thermal stabilizer. However, the results in Table 4 shows the that composition of Comparative Example 1 loses considerably more weight upon heat aging and the results of Tables 5-7 show that the compositions of Examples 1 and 2 retain their physical properties during heat aging considerably better than does the composition of Comparative Example 1.

TABLE 8

| | Example 3 | Comparative Ex. 2 |
|---|---|---|
| Polyoxymethylene | 99 | 99.4 |
| Drapex ® 6.8 | 0.4 | — |
| Polyacrylamide | 0.48 | 0.48 |
| Irganox ® 245 | 0.07 | 0.07 |
| Irganox ® 1098 | 0.025 | 0.025 |
| N,N′-Ethylenebisstearamide | 0.025 | 0.025 |

All quantities are given in weight percent.

The melt viscosity of the compositions of Example 3 and Comparative Example 2 were determined at various shear rates at 190° C. in a Kayeness rheometer. The results are shown in Table 9.

TABLE 9

| | Melt viscosity (Pa · s) | |
|---|---|---|
| Shear rate (s⁻¹) | Example 3 | Comparative Ex. 2 |
| 2075 | 253 | 301 |
| 1037 | 372 | 473 |
| 701 | 426 | 598 |
| 505 | 474 | 711 |
| 308 | 565 | 906 |
| 196 | 685 | 1138 |
| 140 | 807 | 1377 |
| 112 | 896 | 1567 |
| 84 | 1047 | 1850 |
| 56 | 1302 | 2354 |
| 28 | 1936 | 3137 |

The results in Table 9 demonstrate that the presence of epoxidized soybean oil in the composition of Example 3 results in a composition with substantially lower melt viscosity than the composition of Comparative Example 2, a similar composition that does not contain epoxidized fatty acid.

It is therefore, apparent that there has been provided in accordance with the present invention, a polyoxymethylene composition that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

1. A polyoxymethylene composition comprising:
(a) about 40 to about 99 weight percent polyoxymethylene,
(b) about 0.1 to about 5 weight percent of at least one epoxidized fatty acid,
(c) about 0.05 to about 3 weight percent of at least one polymeric stabilizer containing formaldehyde reactive nitrogen groups,
wherein the weight percentages are based on the total weight of the composition.

2. The composition of claim 1, further comprising about 0.01 to about 3 weight percent calcium carbonate.

3. The composition of claim 1, further comprising about 0.01 to about 3 weight percent of a filler comprising glass fibers and minerals.

4. The composition of claim 1, further comprising about 0.01 to about 3 weight percent of a filler comprising talc and wollastonite.

5. The composition of claim 1, wherein the at least one epoxidized fatty acid is one or more of epoxidized soybean oil and epoxidized linseed oil.

6. The composition of claim 1, wherein the at least one epoxidized fatty acid contains 16 to 20 carbon atoms.

7. The composition of claim 1, wherein the at least one polymeric stabilizer comprises at least ten repeat units.

8. The composition of claim 1, wherein the at least one polymeric stabilizer has a weight average molecular weight of greater than 5,000.

9. The composition of claim 1, wherein the at least one polymeric stabilizer has a weight average molecular weight of greater than 10,000.

10. The composition of claim 1, further comprising an antioxidant and/or ultraviolet light stabilizer.

11. The composition of claim 1, further comprising impact modifiers, lubricants, plasticizers, reinforcing agents, nanoclays, flame retardants and nucleating agents.

12. An article prepared from the composition of claim 1.
